(19) United States
(12) Patent Application Publication
(10) Pub. No.: US 2017/0258223 A1
(43) Pub. Date: Sep. 14, 2017

(54) Amplified Electric Guitar Credenza

(71) Applicant: Michael Stampler, Philadelphia, PA (US)

(72) Inventor: Michael Stampler, Philadelphia, PA (US)

(21) Appl. No.: 15/068,575

(22) Filed: Mar. 12, 2016

(51) Int. Cl. A47B 81/00; A47B 88/04; A47B 55/00; H04R 1/02; G10G 5/00

(52) U.S. Cl. CPC A47B 81/005; H04R 1/026; G10G 5/00; A47B 55/00; A47B 88/04; H04R 2201/028; A47B 2210/06; A47B 2220/008; A47B 2220/0091

(57) ABSTRACT

A credenza, the comprising one or more amplifiers, a plurality of speakers, and configured with a slide-out drawer that is shaped to support a guitar when not in use. The credenza may be constructed of dense, thin, and solid wood. A protective material is applied to the interior surface of the slide-out drawer to avoid abrasion of the guitar surface.

### BACKGROUND OF THE INVENTION

The present invention relates generally to a credenza for guitar storage, and more particularly to a combination of a speaker assembly, amplifier, and guitar storage, to provide a multi-functional unit.

Many musicians utilize equipment, which includes not only the guitar itself but speakers, loudspeakers, and amplification devices. These devices are often solo units and when used in conjunction give the desired musical effect to the user. Often times these devices are geared to live performances and to withstand severe travel wear. Due to these characteristics, previous devices do not give the desired aesthetically pleasing combination for home or private use that many collectors and musicians are seeking. In addition, more than one separate units are needed for the desired effect. While prior art provides a combined speaker and amplification system for guitars they fail to address the need for a stationary unit for the home that is both unobtrusive and consistent with home decor.

Currently there is a need in the art for a credenza that is suitable for housing and displaying a guitar in a manner that is both aesthetically pleasing and easy to access, while also using the credenza as an amplifier/speaker system.

### BRIEF SUMMARY OF THE INVENTION

This summary is provided

The present invention provides a credenza for both the storage/display of a guitar and to provide amplified sound forwardly, more particularly to a unique furniture piece containing all the necessary elements for electric guitar storage and a sound playback system.

A credenza, the comprising one or more amplifiers, a plurality of speakers, and configured with a slide-out drawer that is shaped to support a guitar when not in use.

Accordingly it is an object of the present invention to provide a credenza for storing an electric guitar in an aesthetically pleasing manner.

It is an additional object of the present invention to provide a credenza for storing an electric guitar in a manner that is easily accessed.

It is a third object of the present invention to provide a credenza which serves as an electric guitar playback system in an aesthetically pleasing manner.

Other objects and advantages of the present invention will be readily apparent to those skilled in the art upon the reading of the following specification and accompanied drawings.

### BRIEF DESCRIPTION OF THE SEVERAL VIEWS OF THE DRAWING

The drawings are of illustrative embodiments. They do no illustrate all embodiments. Other embodiments may be used in addition or instead. Details which may be apparent or unnecessary may be omitted to save space or for more effective illustration.

FIG. 1 is a perspective view of the credenza in open position

FIG. 2 is a perspective view of the drawer in open position

FIG. 3 is a side view of credenza

FIG. 4 is a perspective view of credenza without speakers

FIG. 5 is a perspective view of credenza with speakers

FIG. 6 is a back view of credenza

FIG. 7 is a front view of credenza

### DETAILED DESCRIPTION OF THE INVENTION

The following detailed description of various embodiments of the invention are set forth in order to provide a thorough understand of various aspects of one or more embodiments of the invention and is not intended to represent the only embodiments. The illustrative embodiments of the invention provided herein are not to be exhaustive or to limit other embodiments. It will become apparent to those skilled in the art that many embodiments of the present invention may be practiced without some or all of the specific details.

As used herein, the term “wood” generally refers to any hard, fibrous substance suitable for construction and other purposes. Wood may refer to any type of wood, including a combination of different woods and synthetic wood, and may be dense, thin, and solid.

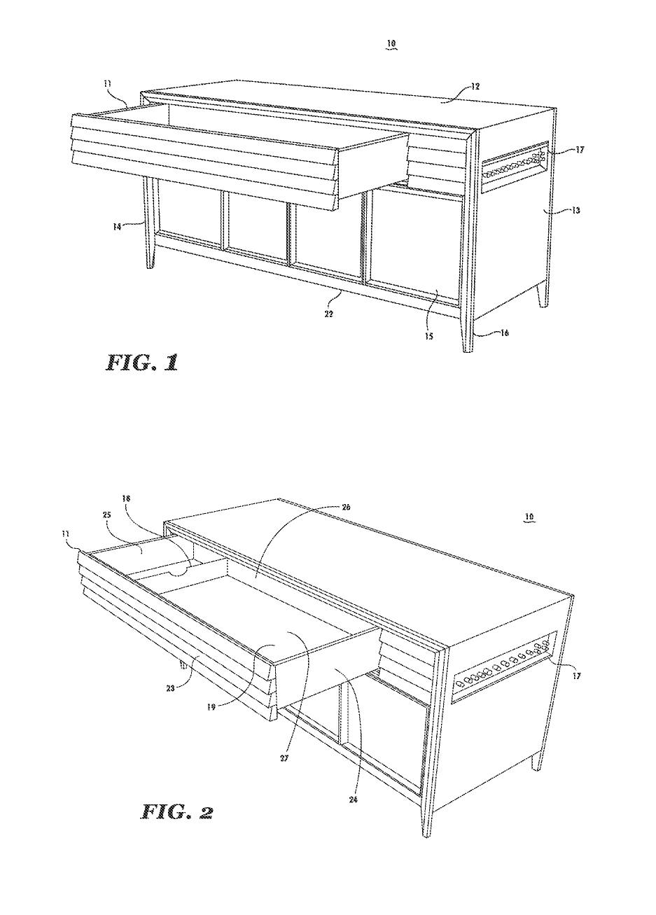

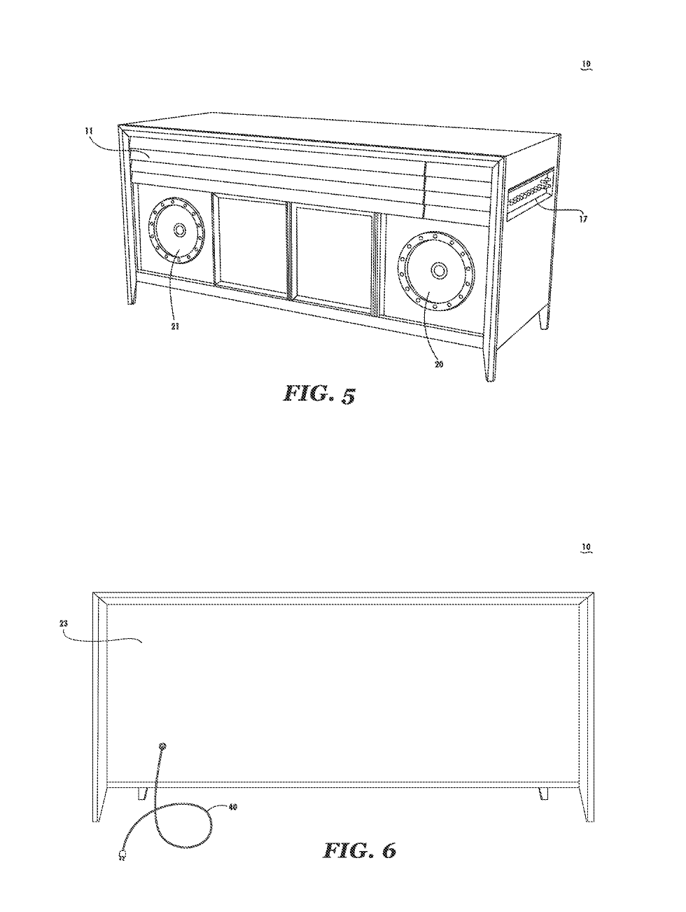

Referring now to the drawings, and particularly to FIG. 1 and FIG. 5, a credenza is shown and generally designated by the number 10. The credenza 10 of the present invention configured with a slide-out drawer 11, at least two speakers 20 and 21, and an amplifier 17. The credenza 10 is designed to sit on the floor. The credenza 10 is constructed in a rectangular shape having a top panel 12 spaced from a bottom panel 22 by side walls 13 and 14 and a back wall 23 and is supported by four feet 16. The credenza 10 can be constructed from wood material, with high strength metallic telescoping slides mounted to the bottom of drawer 11. The components of the credenza 10 may be assembled using standard techniques, including adhesives and hardware fasteners to achieve high strength, unitary construction.

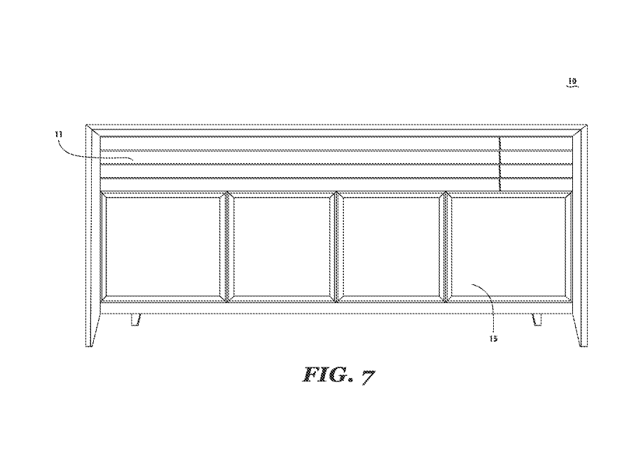

Now referring to FIG. 2., the drawer 11 includes a front panel 23 attached to the forward edge of side panels 24 and 25, with the rear ends of the side panels attached to the ends of a back panel 26. A bottom panel 27 is secured to the bottom edges of the side panels 24 and 25 and back panel 26 and to the front panel 23 above the lower edge of the front panel, so that when the drawer 11 is closed, the front panel 23 closes off the front opening of the credenza 11 as shown in FIG. 7.

As noted above, telescoping slides are used to mount drawer 11 in credenza 10. The telescoping slides can be of “quick release” construction so that the drawer 11 can be conveniently removed from the credenza 10.

The drawer 11 is fitted with a neck support 18 that is utilized with the drawer 11 for supporting the neck of an electric guitar when the instrument is not in use or is being stored. The neck support 18 is in the form of a panel that is in the upright orientation, as shown in FIG. 2. The neck support 18 is held in place by the inside surface of the font panel 23 and back panel 26. The neck support 18 is configured with an upper cutout to receive the guitar neck therein.

To prevent damage to the electric guitar and to provide an aesthetically pleasing view of drawer 11, non-abrasive materials are applied to the neck support 18 and such interior surfaces 19 of the drawer 11 that may contact the hard lacquer finishes of electric guitars. The non-abrasive material in the preferred embodiment is velvet. The velvet is applied to the entire interior surface of drawer 11. However, the interior surface of drawer 11 can be also be applied with other materials of suitable non-abrasive qualities including a variety of fabrics or leathers.

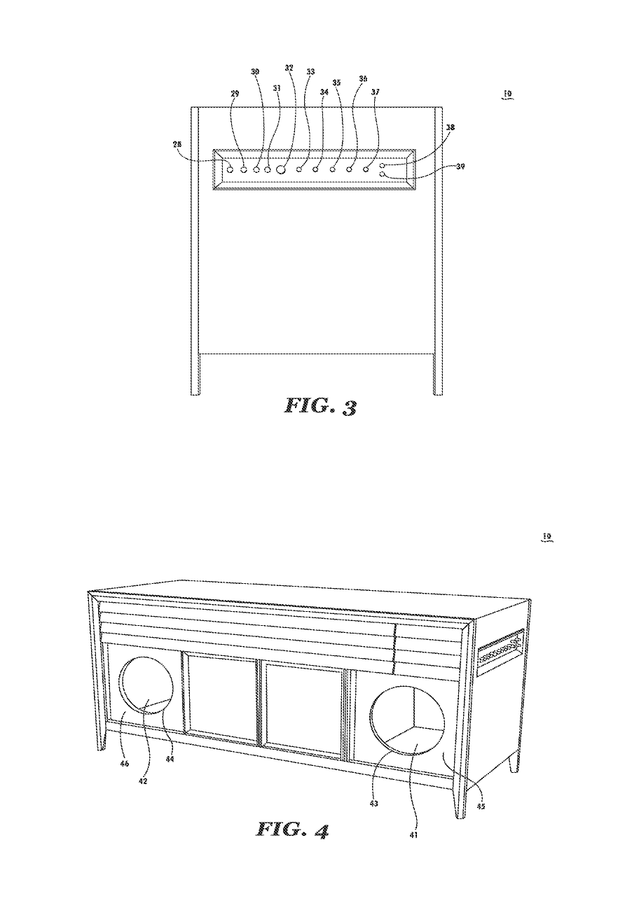

Now referring to FIG. 3, a music amplifier 17 has been built into the credenza 10 sidewall 13. The amplifier has one or more controls such as power switch 28, volume control knob 29, standby switch 30, bass 31, middle knob 32, treble knob 33, reverb knob 34, fuse box 35, ground switch 36, input jack 37 and 38. The amplifier 17 has a standard ¼″ input jack 37 and 38. A separate, standard music cable (not shown) is plugged into either input jack 37 or 38. The other end of such cable is then connected to the electric guitar. Further internal wiring (not shown) connects amplifier 17 to both speaker 20 and speaker 21. By connecting an electrical guitar to said amplifier 17 in a conventional manner, the guitar can be played so that amplified sounds can be produced and made to emanate from speakers 20 and 21.

During construction of the preferred embodiment of credenza 10, certain desirable components, including particular portions of electrical wiring, are built into and hidden within the credenza 10. As mentioned above, the wiring from the alternative music source amplifier 17 is built into the sidewall 13 such that the wiring is connected to the interior of the credenza 10 compartment. Further, as seen in FIG. 6, the power cable 40 for the amplifier is built into the back 23 of the credenza 10 and is of the standard 120 V capacity.

Now referring to FIG. 4 and FIG. 5, one embodiment of the credenza 10 may comprise: a credenza 10; sound cambers 41 and 42; and speakers 20 and 21. As shown, the sound chambers 41 and 42 may contain speakers 20 and 21. The sound chambers 41 and 42 and speakers 20 and 21 are located on the front 15 of the credenza 10. Although FIG. 4 and FIG. 5 are configured to hold and secure two sound chambers and two speakers, the credenza 10 may be configured to hold any number of sound chambers and hold any number of speakers. As shown, speakers 20 and 21 are preferably the same size as each other. In the preferred embodiment, the speakers 20 and 21 may be 10″ speakers.

FIG. 4 is an illustration of a perspective view of one embodiment of the sound chamber speaker to be placed in the credenza 10. As shown in FIG. 4, one embodiment of the sound camber 41 and 42 may comprises a speaker hole 43 and 44 and casing 45 and 46. The casing 45 and 46 may comprise a speaker hole 43 and 44 for securely attaching speaker 20 and 21.

In one embodiment the exterior of the sound chamber 41 and 42 can be entirely or partially covered with speaker grill fabric.

Referring now to FIGS. 1-7, this embodiment discloses a credenza that is suitable for housing and displaying a guitar while also using the credenza as an amplifier/speaker system in a manner that is aesthetically pleasing, consistent with home decor, is easy to access and reliably prevents damage to the electric guitar. Thus it is seen that the present invention readily achieves the ends and advantages mentioned as well as those inherent therein. While certain preferred embodiments of the invention have been illustrated and described for purposes of the present disclosure, numerous changes in parts and steps may be made by those skilled in the art, which changes are encompassed within the scope and spirit of the present invention as defined by the appended claims.

What is claimed is:

1. A credenza comprising:
a. A credenza having a front, an opposing back, two opposing ends, top, and four leg supports;
b. A sound amplifier;
c. One or more speakers;
d. A drawer slidably engageable with the credenza, the drawer having side portions defining a width and front and back portions defining a depth.

2. The credenza of claim 1, wherein said credenza is constructed of wood.

3. The credenza of claim 2, wherein said wood is dense, thin, and solid.

4. The credenza of claim 1, wherein said sound amplifier is built therein.

5. The credenza of claim 1, wherein said cabinet comprise one or more speaker holes.

6. The credenza of claim 5, wherein said one or more speaker holes are positioned at the front of said credenza.

7. The credenza of claim 1, wherein at least one of said one or more speakers is dedicated to producing musical instrument sound.

8. The credenza of claim 7, wherein said one or more speakers are positioned behind said speaker holes.

9. The credenza of claim 1, wherein said drawer comprises a neck support in the drawer adjacent a side portion of the drawer to support the neck of the guitar.

10. The credenza of claim 9, wherein said neck support comprises an upwardly open notch, said notch of a width and contour corresponding to the shape of the neck portion of guitar for receiving the neck portion of the guitar into the notch.

11. The credenza of claim 10, wherein said neck support is held in an upright position.

12. The credenza of claim 1, wherein a non-abrasive material is applied to interior of said drawer.
